(19) United States
(12) Patent Application Publication
(10) Pub. No.: US 2005/0257559 A1
(43) Pub. Date: Nov. 24, 2005

(54) Integrated life safety system and cooling system

(76) Inventor: Steven Joseph Clark, Aetna (CA)

Correspondence Address: STEVEN J. CLARK, P.O. Box 250, BABB, MT, 59411, US

(21) Appl. No.: 11/192,645

(22) Filed: Jul. 29, 2005

(30) Foreign Application Priority Data
Jan. 29, 2003 (GB) 0302025.2
Aug. 8, 2003 (EM) 032S4956.0

(51) Int. Cl. A62C 35/00; F25D 15/00; F25B 27/00; F25D 23/12; F25D 17/02

(52) U.S. Cl. 62/331; 62/434; 169/16

(57) ABSTRACT

A system for providing fire protection and cooling for a building consists of a water cooler which supplies and maintains water in a piping system at a first temperature and a plurality of thermally driven heat extraction assemblies which are located throughout the building. The heat extraction assemblies are thermally linked to the water at the first temperature in the piping system and each heat extraction assembly includes a radiant, naturally convective or forced convective assembly which acts to transfer heat at a second temperature which is substantially higher than the first temperature to water which is passing through the heat extraction assembly.

### TECHNICAL FIELD OF THE INVENTION

The present invention relates to an integrated life safety system/cooling system for existing buildings and, more particularly, to a life safety system that utilises fire sprinkler piping system to distribute the cooling liquids to provide a central cooling system to an existing building.

### BACKGROUND OF THE INVENTION

Traditionally, if the owner of an existing building wanted to substantially improve the life safety and property protection of his building, he could invest in the installation of a fire sprinkler system. This would require the installation of fire sprinkler heads in each room of the building and installing a dedicated piping system from a water source to these heads. While the value of these systems in the savings of human lives and property has been priceless, the real world-building owners generally have not been able to justify installing these in the competitive environment they face.

Also traditionally, adding air conditioning to existing buildings has been done in one of three ways:
1) Installing packaged through-the-wall air conditioners (usually very unsightly and energy inefficient), or
2) Installing split a/c systems with refrigerant piping running to each room (expansive and energy inefficient), or
3) By installing what is known in the art as two pipe chilled water system (expensive but more energy efficient).

The two pipe system consists of a cooling plant and a dedicated chilled water supply and return piping system. The cooling plant supplies cold water through a first dedicated piping system that distributes the cold water throughout the building. Similarly, a second dedicated piping system that collects the used cold water and returns it to the cooling plant. Individual fan coil units placed at various locations throughout the building provide for zonal temperature control. Cooling is provided by having the fan circulate air over a coil that is accessing the cold water piping system. While the two pipe fan coil system provides zonal temperature control, economy of operation, low maintenance, and minimum noise, the relatively high cost of construction the dedicated cold water piping system reduces their popularity.

To avoid the high cost of dedicated two pipe fan coil plus dedicated fire sprinkler systems, this novel invention demonstrates a new means of integrating the two pipe chilled water system with a life safety system.

Prior art in combining building heating and cooling needs with the fire sprinkler systems focused on new construction, where both heating and cooling would be desirable. For the large stock of existing buildings were heating is already installed, these systems would provide an unnecessary and expensive duplication of heating systems.

A combination of heating/cooling and fire suppression system is shown in U.S. Pat. No. 3,939,914 to Carroll. A cooling plant and a heating plant are connected to a single piping system. The piping system is also used for fire suppression purposes. However, because only a single piping system is utilised, the water flowing therein must be a single temperature. Thus, in order to selectively heat and cool different zones of the building, a plurality of compressor type heat exchangers must be located throughout the building. The use of the compressor type heat exchangers allows heating and cooling from a single temperature fluid. However, compressor type heat exchangers are costly, require high maintenance and are relatively noisy.

A combination of heating/cooling and fire suppression system and domestic hot water system is shown in U.S. Pat. No. 5,183,102 to Clark. While this approach avoids the need for compressor type heat exchangers, the integration of the domestic water system in an existing building is normally unacceptable and unnecessary.

Further, neither of the above inventions or anything in the prior art adequately safeguards the fire sprinkler system in event of a failure of the cooling components of the system. This novel invention incorporates a novel flow valve design that meters the flow of cooling water to the fan coils under normal cooling operation. If there is a failure in the cooling piping system downstream of this valve, it is engineered in manner to fail to a shut-off position thereby preventing the loss of fluid from the fire sprinkler system.

Further, both of the above inventions and anything in the prior art utilise electrical energy consuming devices like heat pumps and fan coils to transfer the heat energy from the space. This novel invention includes the option of using radiant heat absorption and natural convection cooling as means of heat extraction. This novel approach, couple with geothermal cooling, in some areas of the world could provide cooling without the need for any mechanical refrigeration and the associated refrigerants and energy use. Additional advantages could be added by coupling this system with other geothermal based systems such as ground water irrigation systems or hydronic snowmelt systems.

Further prior art utilised separate supply and return branch piping to circulate water to fan coils on different levels. This novel invention incorporates a single pipe scheme that can serve multiple levels of heat extraction devices. This piping scheme not only reduces the number of pipes that must be installed but uses the water twice for cooling, thereby reducing the needed cooling flow by 50%. This in turn reduces pipe sizes, pump sizes and pump energy.

The present invention solves these problems and others by utilising an integrated life safety and cooling piping system. The cooling piping system is shared with the fire sprinkler piping system in the case of cold water. By having one integrated piping system, specific zonal control of temperature can be achieved by the use of simple fan coils and life safety and property protection can be achieved by utilizing fire sprinkler heads. Moreover, because the piping systems are integrated to more readily fit in an existing building systems, it can be appreciated that the cost of installing such a life safety and cooling system is relatively low, making it more enticing to the existing building owner.

### SUMMARY OF THE INVENTION

Thus and in accordance with a first aspect of the present invention, there is provided a system for providing fire protection and cooling for a building having a piping system suitable for forming a dual use fire sprinkler/chilled water piping system, said system comprising water cooling means for supplying and maintaining water in said piping system at a first temperature and a plurality of thermally driven heat extraction assemblies located throughout said building, said heat extraction assemblies being thermally linked to said water at said first temperature from said piping system wherein each of said heat extraction assemblies includes radiant, natural convective or forced convective means, which act to transfer heat at a second temperature which is substantially higher relative to said first temperature to water in said heat extraction assembly.

Preferably said heat extraction assemblies include a valve means that meters the flow of said water to the heat extraction assemblies under normal conditions and closes off under a loss of pressure condition.

Preferably said heat extraction assemblies include a first tubing network for carrying said water at said first temperature, and a second tubing network for carrying water at said second temperature and a set of radiating fins, whereby both said first tubing network and said second tubing network are connected to said set of radiating fins to allow thermal transfer to occur.

Advantageously said heat extraction assemblies further include a means of radiant cooling.

Advantages of said heat extraction assemblies further include a means of natural convection cooling.

Furthermore said heat extraction assemblies may further include a fan or a means of forced airflow.

Preferably, said water cooling means is linked to heat extraction devices at different locations in the building using a single pipe. Preferably said water cooling means is a heat exchanger that is connected to a ground water supply source or other geothermal heat sink, such as a hydronic snowmelt system. Advantageously, said water cooling means has a water cooler outlet and a water cooler inlet, said water cooler outlet supplying water into said first piping system and said water cooler inlet receiving water from said first piping system said water at said first temperature maybe continuously circulated by a cold water pump through to the system.

Preferably said first piping system carries fluid used exclusively for fire suppression purposes and cooling said building.

In accordance with a second aspect of the connection there is provided a system for cooling a building comprising water cooling means for providing water at a first temperature, aid water cooling means having a cooler outlet and a cooler inlet, a first piping network for carrying said water at said first temperature, said first piping network receiving said water via said cooler outlet and returning said water to said water cooling means via said cooler inlet, said first piping network further having a plurality of release valves for releasing water, said first piping network comprising a fire sprinkler system for said building and a plurality of heat transfer assemblies located throughout the building, said heat transfer assemblies being thermally linked to water at said first temperature from said first piping network, wherein each of said heat transfer assemblies, act to transfer heat at said second temperature to said water at said first temperature.

Preferably said second heat transfer assemblies include a first tubing network for carrying said water at first temperature, and a second tubing network for carrying water at said second temperature and further comprising a set of radiating fins, whereby both said first tubing network and said second tubing network are connected to said set of radiating fins whereby thermal transfer may occur.

Preferably wherein said heat transfer fan coil assemblies further include valve means for controlling the flow of water to said first tubing network and said second tubing network.

Preferably said second temperature is less than an air temperature of a space to be cooled and said first temperature is less than said air temperature.

Preferably said water cooling means is a heat exchanger that accesses a ground water supply source. Alternatively, cooling could be provided in some parts of the world during some seasons by rejecting heat through a series of tubes buried in or beneath sidewalks and driveways near the said building. This heat rejection system could offer the additional benefit of melting snow from these surfaces, further enhancing safety.

Preferably apparatus wherein said water at said first temperature is continuously circulated by cold water.

Preferably said first piping network carries fluid for fire suppression purposes and cooling said building.

### BRIEF DESCRIPTION OF THE DRAWINGS

The foregoing aspects and many of the attendant advantage of this invention will become more readily appreciated as the same becomes better understood by reference to the following detailed description, when taken in conjunction with the accompanying drawing, wherein:

FIG. 1 is a schematic view of the present invention for a two story building incorporating the present invention using ground water directly as a cooling source and radiant and convective cooling to deliver the cooling effect to the space without the use of compressors or fans.

FIG. 1 also shows an embodiment of the automatic shut off valve incorporated in the present invention; and

FIG. 1 also shows the single pipe riser design for use in the present invention.

### DETAILED DESCRIPTION OF THE PREFERRED EMBODIMENT

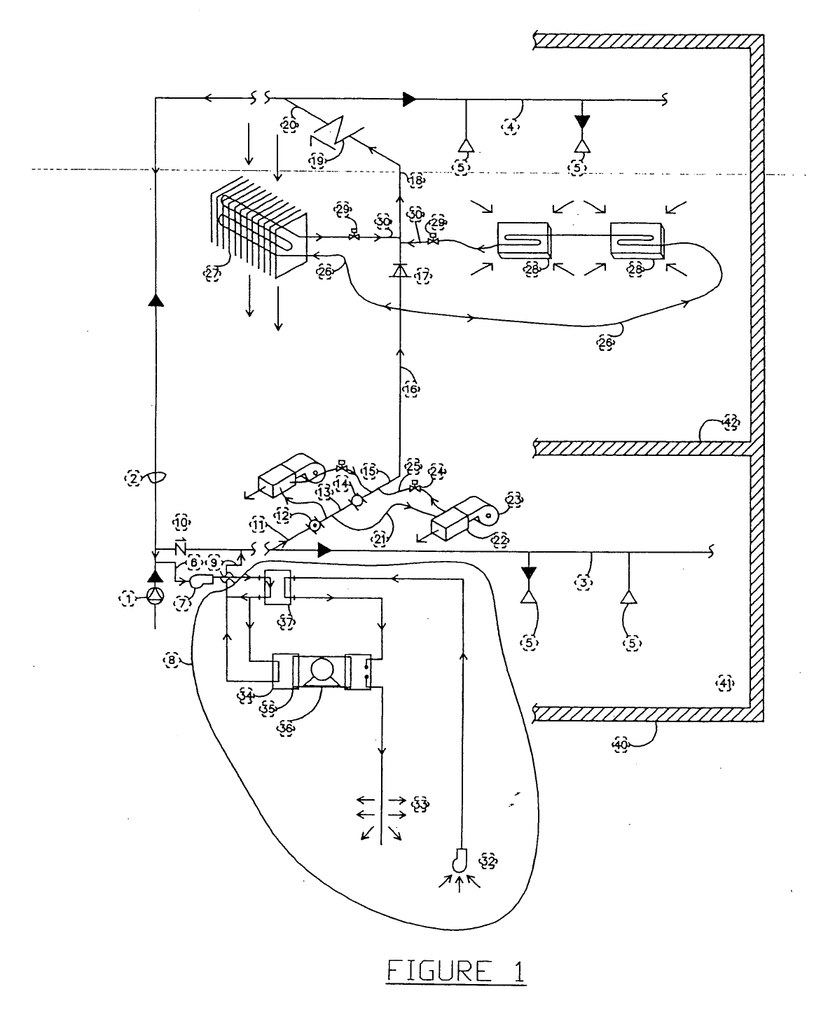

Referring to FIG. 1, a portion of an existing multi-story building is generally shown by reference numeral 40. The portion of the building shown includes a ground story 41 and a second story 42. For the purpose of life safety and for property protection, a fire

Sprinkler piping system is to be integrated therein. In FIG. 1, the fire sprinkler piping system is generally comprised of a cold water service entry 1, a cold water supply riser 2, a cold water supply main serving the lower floor 3, a cold water supply main serving the upper floor 4, a plurality of cold water supply branches and a plurality of release valves 5.

The fire sprinkler piping system described herein provides a continuously circulating water supply. Specifically, still referring to FIG. 1, a water cooler 8 is integrated into the fire sprinkler piping system. In the illustrated embodiment, the water cooler 8 is a heat exchanger that utilises ground water accessed via a well in order to cool the water in the fire sprinkler piping system. In operation, a pump 32 circulates ground water into the water cooler 37 via a separate independent piping network. Also circulating within water cooler 37 is the water in the fire sprinkler piping system. By known thermodynamic processes, the water in the fire sprinkler piping system is cooled to nearly the temperature of the ground water.

Although described above is one type of water cooler, it can be appreciated by those skilled in the art that other methods of cooling the water in the fire sprinkler piping system may be utilised, such as a mechanical cooler, a thermal storage device, or a combination of cooling sources as shown in FIG. 1, water cooler 8. This shows water being cooled directly in heat exchanger 37 by ground water pumped from pump 32, and the ground water then cools a mechanical cooler 34, 35, and 36 and returns to ground 33. The evaporator of the mechanical cooler 34 can further cool the cold water for use in cooling the building. An additional option, to provide space cooling during cool weather is to transfer the heat energy via a heat exchanger to a series of tubes buried in or beneath sidewalks and driveways, thereby providing both building heat rejection and a snow melt system.

A cold water pump 7 maintains circulation of the cold water in the fire sprinkler piping system. The cold water pump 7 draws water by pipe 6 from cold water supply riser 2 and acts to circulate cold water vertically down the cold water supply riser 2. Distribution of water to lower story is accomplished by the cold water supply 9 feeds branch 3 that generally run laterally from the cold water supply riser 2. For simplicity, only one cold water supply branch is shown for each story; however, it can be appreciated that a plurality of cold water branches may be utilised, and multiple floors may be served in a similar manner. In communication with each cold water supply branch 3 is a cooling water supply riser branch 11, 15, 16, 18, 20 that supplies the water to the cooling terminal units 24, 27, & 28 as well as returning the water to the cold water return main 4. The cold water return main 4 returns the water back to water cooler 8 where the water is cooled and returned back into cold water supply main 3. In sum, water is circulated from the water cooler 8, through the cold water supply main 3, up the cold water supply branch 11, returning to the cold water return main 4, down cold water return riser 2, and back to water cooler 8.

The risers 2 and 16 are typically located in the interior walls of the building. The cold water supply mains are typically located above the ceiling on each floor. The cold water branches 21 and 26 are typically located above the ceilings on each floor. The cold water branches 21 and 26 are, in the preferred embodiment, constructed of tubular piping. The release valves 5 are incorporated into the cold water branches 3 and 4 and extend downwardly into the interior of each story such that emergency fire suppression may be accomplished.

Although FIG. 1 shows two release valves 5 per story, it can be appreciated that more may be utilised. As is known in the art, release valves 5 allow water in the cold water branches 3 and 4 to flow outward when a fire is detected, thereby suppressing the fire. The heavy dark flow arrows indicate water flow in the fire suppression mode.

For simplicity, the fire sprinkler piping system has been described and shown as a closed loop system, whereby the same water is circulated continuously within the fire sprinkler piping system. However, it can be appreciated that an outside water source must be available for replenishing the water in the fire sprinkler piping system during fire suppression. For example, a municipal water main is connected to cold water service entry 1. The cold water service entry may then inject water from the municipal water main into the fire sprinkler piping system when necessary.

The present invention utilises the above described piping system to cool the building. Located throughout the building are a plurality of heat extraction devices 22, 27, & 28. The heat extraction devices 25 are the actual cooling sources within the building.

Although FIG. 1 shows only two stories of a multi-story building with two heat extraction devices 25 for each story, it should be appreciated that the present invention is intended to be utilised for single-story and multi-story buildings of any number of stories and with any number of heat extraction devices located throughout each story.

FIG. 1 shows three different types of heat distraction devices. On the first floor are shown fan coils consisting of a fan 23 and a cooling coil 22. In this heat extraction device the fan draws air from the space and forces the air through the cooling coil 22. At the same time the cooling control valve 24 opens up allowing cold water to flow into tubing 21, pass through the cooling coil 22 and exit through tubing 25. Through the thermodynamic process known as forced convection the warm air is cooled by heat transfer through the cooling coil 22 and the heat is carried away by the cold water supply. The cold water then returns to cold water riser 15. The second story of the building demonstrates two alternative heat extraction devices; number 27 is a connective cooling coil, and numbers 28 are two radiant cooling panels. The cold water enters the convective cooling coil through tube 26 and cools the thin material of the convector. This cool material cools the surrounding air of the coil, which grows heavier, and drops from the coil. This draws warmer air in to the top of the convective cooler as the process continues. Warmer water leaves through tubing 30. This process continues as long as control valve 29 is in the open condition. When sufficient cooling has been achieved control valve 29 will then close. A similar process is shown on the other side of the second story of the building shown in FIG. 1. The second story is 42 of the building 40 shown in FIG. 1. The heat extraction device shown here are radiant panels which absorb radiant energy from surrounding space. Again these panels become operational when cold water flows through tube 26 into the radiant panels cooling them below the temperature of the surrounding space. Warmth radiates in from surrounding objects heating the cold water as it passes through the panel. The water then leaves through conduit 30 whenever control valve 29 is in the open position.

Several unique piping features are also illustrated in FIG. 1. First is the flow metering/automatic shut off valve 12 located immediately adjacent to cold water branch 11 ties into cold water supply main 3. This valve has two main functions. Under normal cooling operation this valve with its total flow into branch line 11 to a constant preset quantity of cold water. Cold water flow can drop below this amount this valve limits the flow so that it does not rise above this amount. However if there should be a failure of equipment or piping downstream of flow metering/shut down valve 12, this valve will sense a loss of pressure in the downstream line and will fail to a closed position. This feature protects the fire/sprinkler system in the case of a failure in the piping in the cooling sections of the system.

Flow metering valve 14 has the function of letting a specified minimum flow to bypass the fan coils on the lower level and go directly to riser 16 to serve the fan coils on the upper level. Additionally due to the flow restrictions of this valve the cold water is forced to flow to the heat extraction devices on this floor through tubing 21 and return after this valve through tubing 25.

Flow diversion bypass valve 17 is located on the upper story and creates a closed restriction to flow from riser 16 up to riser 18 if alternative paths are available through tube 26. This forces the cold water to flow through tube 26 and through heat extraction devices 27 or 28. When ever control valve 29 are open water then returns through tube 30 back into cold water supply riser 18. However if all control valves 29 are in the closed position this will result in a build up of pressure upstream of valve 17 and valve 17 will then open to let cold water flow through to riser 18. This feature allows cooling to take place on the lower floor even if no cooling is required on the upper floor. Thereby though proper sizing of valves 12, 14, and 17 cooling water can be adequately distributed to both the lower and upper floors using a single pipe. This again reduces the insulation cost of running separate supply and return piping risers from floor to floor as is the conventional approach. Cold water from riser 18 is allowed to pass through a non return or check valve 19 before passing through conduit 20 and returning to cold water return main 4. Water is then allowed to circulate back down through cold water return riser 2 and back to cold water circulating pump 7, thereby completing a loop.

If cooling is desired, cold water valves 24 or 29 are opened to allow water from cold water supply branch 11 or 16 to flow into the cold water tubing 21 or 26 to flow to heat extraction devices 22, 27 or 28. Heat is transferred via known thermodynamic processes of forced convection, natural convection or radiation from the air to the water. The water is returned by cold water control valve 24 or 29 and via the tubing 25 or 30 to cold water riser 15 or 18.

As can be seen in the description above, zonal temperature control may be accomplished by utilizing a plurality of heat extraction devices. Moreover, in contrast to the prior art, the heat extraction devices 22, 27, & 28 are relatively simple in manufacture as compared with compressor type heat exchangers operating off of a single temperature fluid. As can be appreciated by those skilled in the art, a single temperature fluid heating and cooling system requires a complex heat exchanger including an evaporator and compressor in order to generate cooling or heating from a single temperature fluid.

Additionally, the compressor type heat exchangers require large amounts of power and are relatively noisy. In contrast, the fan coil assemblies 22 & 23 require only a small amount of power to drive the fan, and convective heat extraction devices 27 and radiant heat extraction devices 28, both require no power input. By having a cold water supply to each heat extraction assembly, cooling can be accomplished without the expense of having a plurality of evaporators and compressors. Moreover, by utilizing the fire sprinkling system to carry the cold water supply, additional savings are realized. Specifically, initial building costs are greatly reduced by eliminating the need for dedicated piping systems.

It is of course to be understood that the invention is not intended to be restricted to the details of the above embodiments which are described by way of example only.

Thus for example, in some locations, existing water supplies are not of sufficient size or reliability to meet fire protection requirements. In these instances it can be necessary to install a further water tank to meet these requirements. These tanks can be quite large, taking up valuable space and are typically seen by users as an initial expense and maintenance item, with no direct payback. This makes such arrangements unattractive to potential users. However, integrating the cooling and fire protection systems as mentioned above can turn the fire tank into a cash flow item overcoming this problem. By insulating the tank and by providing a means of thermal exchange between the tank water and the cooling loop, the fire tank can double as thermal storage tank. This will allow the system to produce the chilling effect at night time when outside temperatures are cooler and electric rates are lower to cool the water in the tank. Then at peak daytime hours, the cool water in the tank can be used to meet the building's cooling demand, saving the purchase of expensive peak power. In some climates, during certain seasons, it may be possible to cool the tank water with heat exchange only without the need for refrigeration, providing additional savings. In addition to the energy and power savings, this feature also could be used to reduce the size of chiller plant needed to cool a building and could allow a building to maintain cooling even during a short power outage.

While many ways of providing the thermal exchange between the tank and the chilled water are possible, three methods are considered most effective. First, it is possible to directly pump the water from the fire tank into the cooling/fire loop, and then provide a place for the water to flow back to the tank. However, some fire codes may prohibit this approach. Alternatively, one could pump from a fire tank water to a water-to-water heat exchanger coupled with the cooling system. Thirdly, one could install a chilled water piping loop in the storage tank. When extra cooling capacity is available, the chilled water is allowed to flow through this loop, cooling the water in the tank. Then during the peak cooling hours, warm return chilled water would pass through this tank loop, and thereby be cooled.

1. A system for providing fire protection and cooling for a building having a piping system suitable for forming a dual use fire sprinkler/chilled water piping system, said system comprising water cooling means for supplying and maintaining water in said piping system at a first temperature and a plurality of thermally driven heat extraction assemblies located throughout said building, said heat extraction assemblies being thermally linked to said water at said first temperature from said piping system wherein each of said heat extraction assemblies includes radiant, natural convective or forced convective means, which act to transfer heat at a second temperature which is substantially higher relative to said first temperature to water in said heat extraction assembly.

2. A system according to claim 1, wherein said heat extraction assemblies include valve means that meet as the flow of water to the heat extraction assemblies under normal conditions and closes off under a loss of pressure condition.

3. A system accordingly to claim 1 or claim 2, wherein said heat extraction assemblies include a first tubing network for carrying said water at said first temperature, and a second tubing network for carrying said water at said second temperature and a set of radiating fins, whereby both said first tubing network and said second tubing network are connected to said set of radiating fins to allow thermal transfer to occur.

4. A system according to any one of claims 1 to 3, wherein said heat extraction assemblies include a means of radiant cooling.

5. A system according to any one of claims 1 to 3, wherein said heat extraction assemblies further include a means of natural convection cooling.

6. A system according to any one of claims 1 to 3, wherein said heat extraction assemblies further include a fan or a means of forced air flow.

7. A system according to claim 1, wherein said water cooling means is linked to heat extraction devices at different locations in the building using a single pipe.

8. A system according to claim 7, wherein said water cooling means is a heat exchanger which is connected to a ground water supply source.

9. A system according to claim 7 or claim 8, wherein said water cooling means has a water cooler outlet and a water cooler inlet, said water cooler outlet supplying water into said first piping system and said water cooler inlet receiving the water from said first piping system, said water at said first temperature being continuously circulated by a cold water pump through the system.

10. A system according to any one of claims 1 to 9, wherein said first piping system carries fluid used exclusively for fire suppression purposes and cooling said building.

11. A system for cooling a building comprising water cooling means for providing water at a first temperature, said water cooling means having a cooler outlet and a cooler inlet, a first piping network for carrying said water at said first temperature, said first piping network receiving said water via said cooler outlet and returning said water to said water cooling means via said cooler inlet, said first piping network further having a plurality of release valves for releasing water, said first piping network comprising a fire sprinkler system for said building and a plurality of heat transfer assemblies located throughout the building, said heat transfer assemblies being thermally linked to water at said first temperature from said first piping network, wherein each of said heat transfer assemblies, act to transfer heat at said second temperature to said water at said first temperature.

12. A system according to claim 11, wherein said second heat transfer assemblies include a first tubing network for carrying said water at said first temperature, and a second tubing network for carrying water at said second temperature and further comprising a set of radiating fins, whereby both said first tubing network and said second tubing network are connected to said set of radiating fins whereby thermal transfer may occur.

13. A system according to claim 11 or claim 12, wherein said heat transfer fan coil assemblies further include valve means for controlling the flow of water to said first tubing network and said second tubing network.

14. A system according to any one of claims 11 to 13, wherein said second temperature is greater than an air temperature of a space to be heated and said first temperature is less than said air temperature.

15. A system according to any one of claims 11 to 14, wherein said water cooling means comprises a heat exchanger that accesses a ground water supply source.

16. A system according to any one of claims 11 to 15, wherein first piping network carries fluid for fire suppression purposes and cooling said building.

17. A system according to claim 1, substantially as herein before described with reference to the accompanying drawings.

18. A system according to claim 11, substantially as herein before described with reference to the accompanying drawings.
